(19) United States
(12) Patent Application Publication
(10) Pub. No.: US 2012/0223033 A1
(43) Pub. Date: Sep. 6, 2012

(54) MODULAR SUPPORT CONSTRUCTION

(76) Inventor: Efraim Molek, Herzliya (IL)

(21) Appl. No.: 13/509,220

(22) PCT Filed: Nov. 11, 2010
(86) PCT No.: PCT/IL10/00938

§ 371 Date: May 10, 2012

(30) Foreign Application Priority Data
Nov. 12, 2009 (IL) 202079

(51) Int. Cl. F24J 2/52; F16M 11/00

(52) U.S. Cl. 211/41.1; 211/182

(57) ABSTRACT

Provided is an elongate construction element including a rigid elongate tubular body formed with at least one longitudinal U-like shaped groove. The groove is defined between a pair of facing side walls and a base wall spanning therebetween. The side walls are each formed with a plurality of parallely extending, spaced apart longitudinal ribs projecting therefrom, which together mimic a portion of a nominal threaded bore. The groove is formed such that the ratio between the height of the groove and the distance between the side walls is no greater than 1.8. The axial force in newtons necessary to remove a screw threaded therein the groove and fully penetrating the base wall is less than 3.7 times the product of the tensile yield strength of the material of the construction element and the distance between the sidewalls in millimeters.

### FIELD OF THE INVENTION

The presently disclosed subject matter relates to a support construction, its components and its assembly. More particularly, the present invention is concerned with a modular support system, components and its assembly.

A support construction according to the present disclosed subject matter is suitable for supporting a variety of different elements, such as, for example, solar panels, construction of dwellings, wall/roof/partition construction etc.

### BACKGROUND OF THE INVENTION

Is often required to erect a rigid structure or a support structure at short time while maintaining cost low on the one hand, and on the other hand obtaining a rigid, strong and reliable structure.

A variety of modular structures are known. For example, EP 0 976 891 discloses a structural profile for a construction system wherein at least one tension lock is inserted into the at least one chamber in the core part of the profiled support. The chamber for the tension lock is integrated in at least one adapter inserted into guides pointing towards the interior of the profiled support. The guides have through-holes into which screws fit axially securing the adapter in the guides. The adapter has side openings for operating cams of the tension locks. The facing narrow sides of the plate-shaped adapter have guides matching the other guides.

US 2005/034390 discloses an air handling unit (AHU) for housing a number of components used in a heating or cooling system to provide forced air for climate control in a particular structure includes a single raceway construction having both low thermal conductivity and enhanced mechanical properties for use with lifting the AHU; a single insulated panel construction having a minimum number of components as well as enhanced mechanical properties for use as the floor in an AHU compartment; to minimize costs associated with fabrication and installation.

### SUMMARY OF THE INVENTION

The disclosed subject matter is concerned with a support construction system and its components which facilitate modular construction for fast erecting of rigid support structures.

According to one aspect of the present disclosed subject matter there is disclosed a coupler system comprising a beam element configured with at least one groove extending parallel to a longitudinal axis of the beam, in which a pair of facing side walls are formed with a plurality of parallely extending, spaced apart longitudinal ribs, which together mimic a portion of nominal threaded bore. Said groove is U-like shaped, i.e. having two ribbed side walls and a base wall portion extending therebetween.

The present disclosure is further directed to a construction system comprising a construction beam extending along a longitudinal axis, and an insert coupling beam snugly slideable within the construction beam and fixedly secured by virtue of at least threaded fasteners extending therethrough; wherein at least one of said construction beam and said insert coupling beam is configured with at least one groove extending parallel to said longitudinal axis, in which a pair of facing side walls are formed with a plurality of parallely extending, spaced apart longitudinal ribs, which together mimic a portion of nominal threaded bore. Said groove is U-like shaped, i.e. having two ribbed side walls and a base wall portion extending therebetween. The groove is formed such that:

H/D≦1.8

wherein H is the height of the groove, and D is the distance between the side walls, and wherein the axial force necessary to remove a screw threaded therein the groove and fully penetrating the base wall is given by:

F<3.7×TYS×D

wherein F is the axial force in newtons, and TYS is the tensile yield strength in N/mm² of the material of the construction beam.

By referring to a portion of a bore mimicking a nominal thread it is meant that a threaded nut-like portion is configured, having a nominal threading dimension, with spaced apart walls which do not constitute a bore with a closed wall, but however suffices for screw coupling with a screw of respective nominal diameter. It is appreciated that the longitudinal ribs of the facing side walls of a groove are configured at vertical shift, i.e. the facing ribs are not equi-leveled.

Furthermore, the base wall portion may be thickened to assume a v-like shape, thereby increasing surface area contact with a screw penetrating therethrough, i.e. improving thread gripping of the screw. This results in better shear/tear resistance. Such an arrangement enlarges the surface area of contact between the base wall portion and a screw penetrating therethrough, without a corresponding increase in the force necessary to penetrate therethrough or the ability of the screw to penetrate the base wall without changing the ratio of the height of the groove to the distance between its walls.

One advantage of the arrangement is that it facilitates applying a screw at any desired location along the construction element, however without any restriction to the provision of pre threaded bores. Yet an advantage facilitates pre-introducing of one or more screws into the so-called threaded grooves. Even more so, upon applying a self point tapping screw through the groove of a construction element, substantially no axial force is required for the penetration of the screw through the material, but rather only torque. It is however noted that the material at the base of the groove may be penetrated also by using a self tapping screw (a self drilling screw or pre-drilling are not required).

Once a portion of the screw stem is already engaged with the ribbed walls of the grove, and after penetration of the screw through the material at the base of the groove, the screw is well maintained in the elongate beam and its extraction requires considerable force. This is owing to the fact that the screw threads are engaged with the ribbed walls and with the solid material at the base of the groove.

A construction system according to the present disclosed subject matter may be suitable for a variety of support structures, According to one particular application the system is constructed for bearing a plurality of solar panels secured thereto by a plurality of fasteners configured for screw coupling to the longitudinal grooves.

The presently disclosed subject matter is concerned also with an elongate construction element comprising a rigid elongate tubular body formed with at least one longitudinal groove configured with a pair of facing side walls each formed with a plurality of parallely extending, spaced apart longitudinal ribs, which together mimic a portion of nominal threaded bore.

According to one embodiment there is provided a construction beam extending along a longitudinal axis and formed with at least one longitudinal groove parallel to said longitudinal axis and configured with a pair of facing side walls each formed with a plurality of parallely extending, spaced apart longitudinal ribs, which together mimic a portion of nominal threaded bore.

According to still an embodiment there is disclosed an insert coupling beam for a construction system, said insert coupling beam configured for snugly sliding within a construction beam and for fixedly securing thereto by virtue of at least one fastener, said insert coupling beam configure\d with at least one longitudinal groove in which a pair of facing side walls are formed with a plurality of parallely extending, spaced apart longitudinal ribs, which together mimic a portion of nominal threaded bore.

Any one or more of the following designs and features may be associated with the support construction system and its components:
the construction beam is fitted with at least a pair of longitudinal ribs for coupling thereto a raceway concealing cover;
the raceway concealing cover is slidingly articulated within the longitudinal ribs of the construction beam;
the raceway concealing cover is snappingly articulated within the longitudinal ribs of the construction beam;
the at least one longitudinal groove is configured for receiving a screw (corresponding with the nominal threading) axially screwed into a longitudinal groove (however, in this configuration the threaded screw will form new threads in the longitudinal ribs);
the longitudinal ribs are configured for receiving a screw (corresponding with the nominal threading) screwed axially into the longitudinal ribs (however, in this configuration the threaded screw will form new threads in the longitudinal ribs);
one or more of the one or more longitudinal grooves comprises a double walled base wall extending between the two ribbed side walls, the two (or even more) base walls being spaced apart and parallel to one another according to a particular configuration;
the one or more base walls of the longitudinal grooves has a tapering cross section with an apex extending at a midsection of the respective groove;
a coupling bracket is provided for coupling at least one second construction beam to a first construction beam at an intersecting angle, said coupling bracket comprising a first flanged portion for articulation to the first construction beam and at least one second flanged portion for articulation to the at least one second construction beam, wherein said flanged portions are formed with apertures conforming with the location of the at least one groove formed on each construction beam;
a coupling bracket is provided for coupling a second construction beam to a first construction beam at an intersecting angle, wherein said coupling bracket comprises a second construction beam receiving portion and at least one securing flap for fastening flush against said first construction beam, both said receiving portion and said at least one securing flap are fitted with apertures positioned in register with the longitudinal groove for screw coupling therewith;
the coupling bracket comprises three securing flaps of which two extend coplanar and are configured for securing to a first surface of the first construction beam, and a third securing flap for securing to a second surface of the first construction beam;
a support bracket is provided for supporting an end of a construction beam over a surface, said support bracket comprising a flanged portion for fixedly receiving the end of the construction beam, and a bearing portion for placing the support bracket over a surface, wherein said flanged portion is pivotally secured to the bearing portion;
the flanged portion and the bearing portion are pivotally articulated by a fastener element projecting for fixing to the surface in a liquid tight arrangement;
the trough-like shaped bearing portion of the support bracket is padded;
the bearing portion of the support bracket has a substantially trough-like shape;
the at least one longitudinal groove is open ended;
the at least one longitudinal groove is U-like shaped.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a front perspective view of a solar panel array mounted on a support construction in accordance with the present disclosure;

FIG. 1B is a rear perspective view of FIG. 1A;

FIG. 1C is an enlargement of the portion marked III in FIG. 1B;

FIG. 1D is a side view of FIG. 1A;

FIG. 1E illustrates a solar panel array mounted on a support system in accordance with the disclosed subject matter fitted on a corrugated roof portion;

FIG. 1F is a perspective view of a ground mounted construction system supporting a solar panel array;

FIG. 1G is an enlargement, at a rear perspective view of the portion marked II in FIG. 1F;

FIG. 1H is an enlargement of the portion marked II in FIG. 1F;

FIG. 1I is an enlargement of the portion marked I in FIG. 1E;

FIG. 2 illustrates a support system in accordance with the disclosed subject matter fitted for mounting on a tiled roof;

FIG. 3 is an exploded isometric view of several components used in a construction system in accordance with the present disclosed subject matter;

FIG. 4A is a perspective view of a construction beam used with a construction system of the present disclosed subject matter, fitted with a raceway cover at an open position;

FIG. 4B is a front view of FIG. 4A;

FIG. 5A is a right side isometric view of an assembled portion of a construction system in accordance with the disclosed subject matter and also fitted with a solar panel coupler;

FIG. 5B is a left, front isometric view of FIG. 5A;

FIG. 5C is a front view of FIG. 5A;

FIG. 6A is a front view of an insert coupling beam received within a construction beam and with a raceway concealing cover at an open position;

FIG. 6B illustrates penetration of screws into the assembly of FIG. 6A and with the raceway concealing cover at its closed position;

FIGS. 7A to 7D are respective longitudinal sections along line V-V in FIG. 5A;

FIGS. 8A to 8C are perspective views of alternative examples of construction beams according to the disclosed invention;

FIG. 9 is a perspective view of an alternative example of an insert coupling beam according to the disclosed invention;

FIGS. 10A and 10B are perspective views of panel couplers for use in conjunction with a construction beam or an insert coupling beam according to the disclosed invention;

FIGS. 11A to 11K are examples of coupler brackets for use in conjunction with a construction beam or an insert coupling beam according to the disclosed invention;

FIGS. 12A to 12C are perspective views of further alternative examples of construction beams according to the disclosed invention;

FIGS. 13A is an isometric view of a beam configured with ribbed grooves according to another example;

FIG. 13B is an elevation of the beam of FIG. 13A;

FIG. 13C is an enlargement of the portion marked XIII in FIG. 13B;

FIGS. 14A to 14D are enlargements of the portion marked XIII in FIG. 13B, illustrating consecutive steps of fastening a screw into the; and

FIG. 14E illustrates the beam of FIG. 13B with the screw screwed into the groove.

### DETAILED DESCRIPTION OF EMBODIMENTS

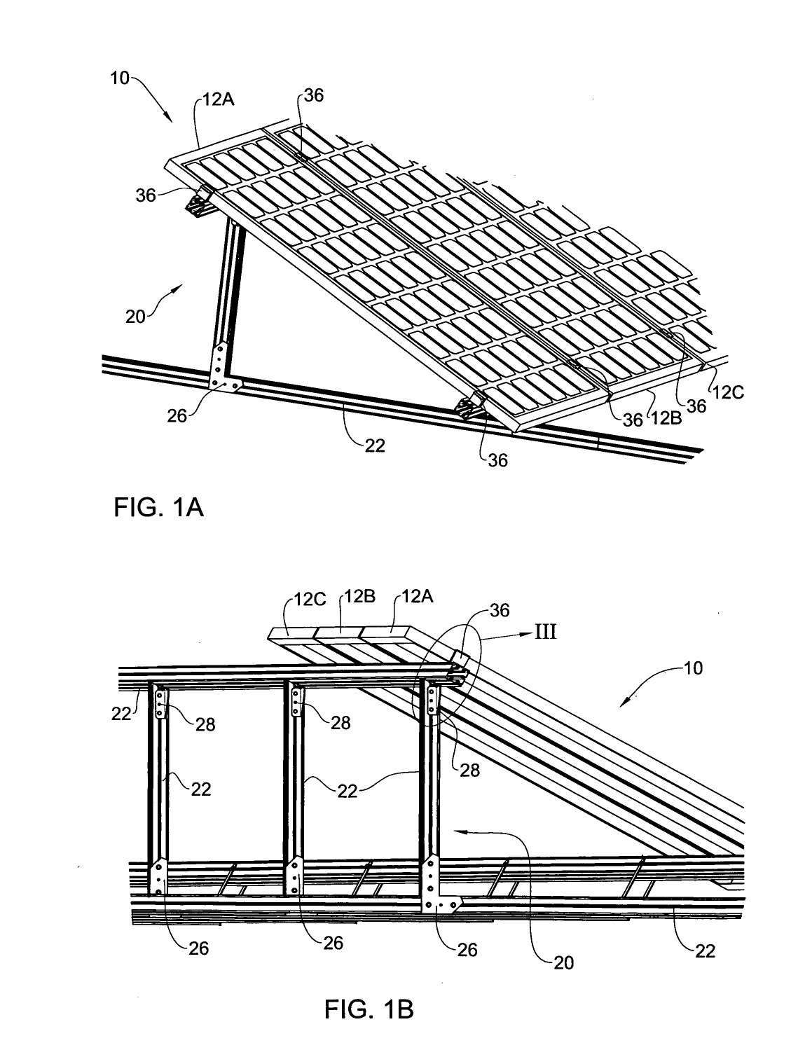

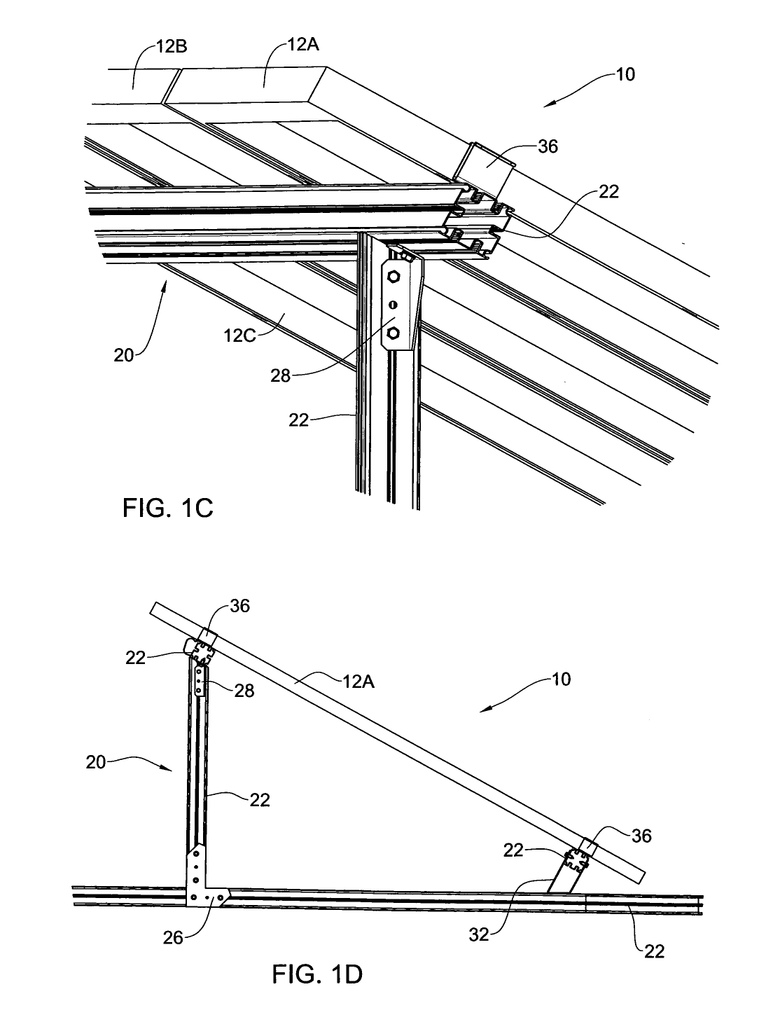

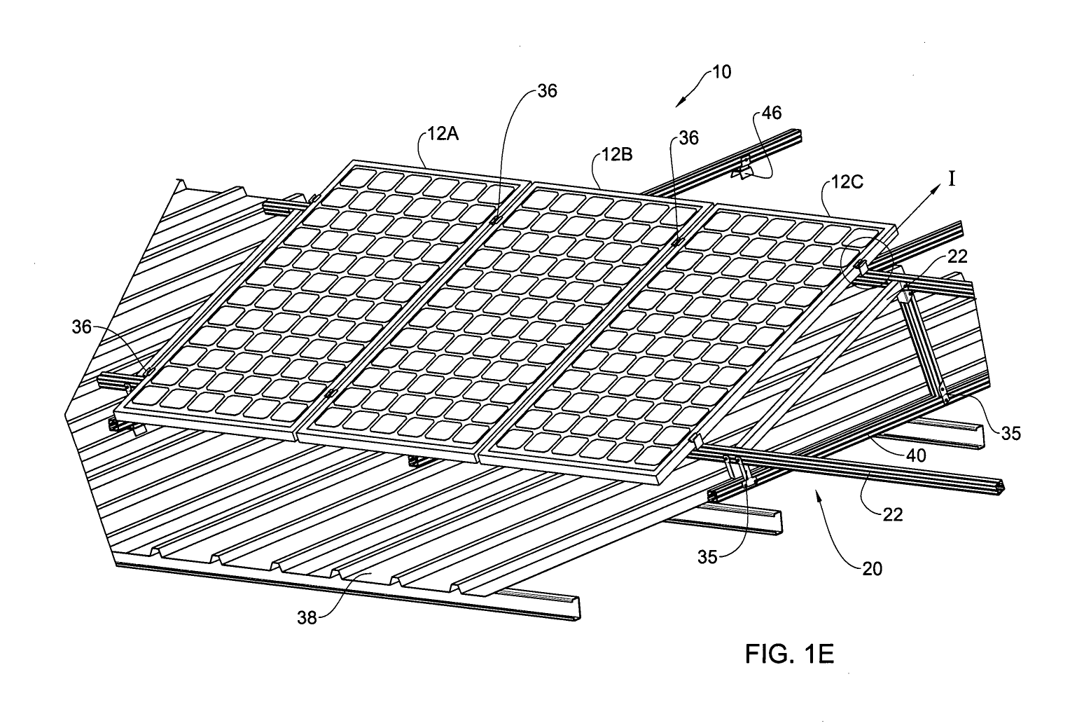

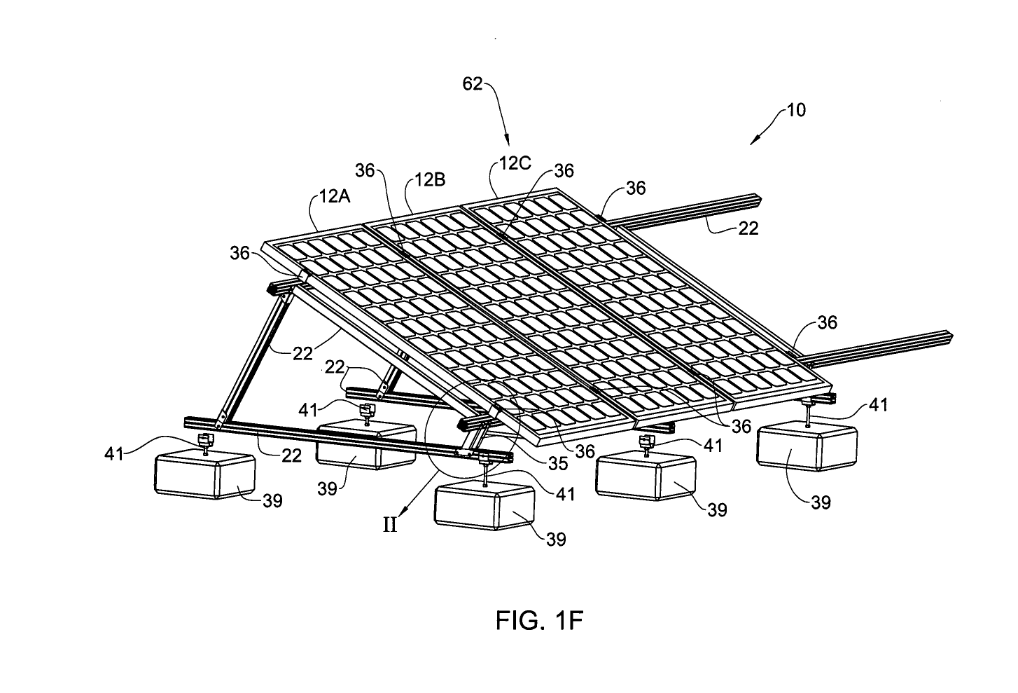

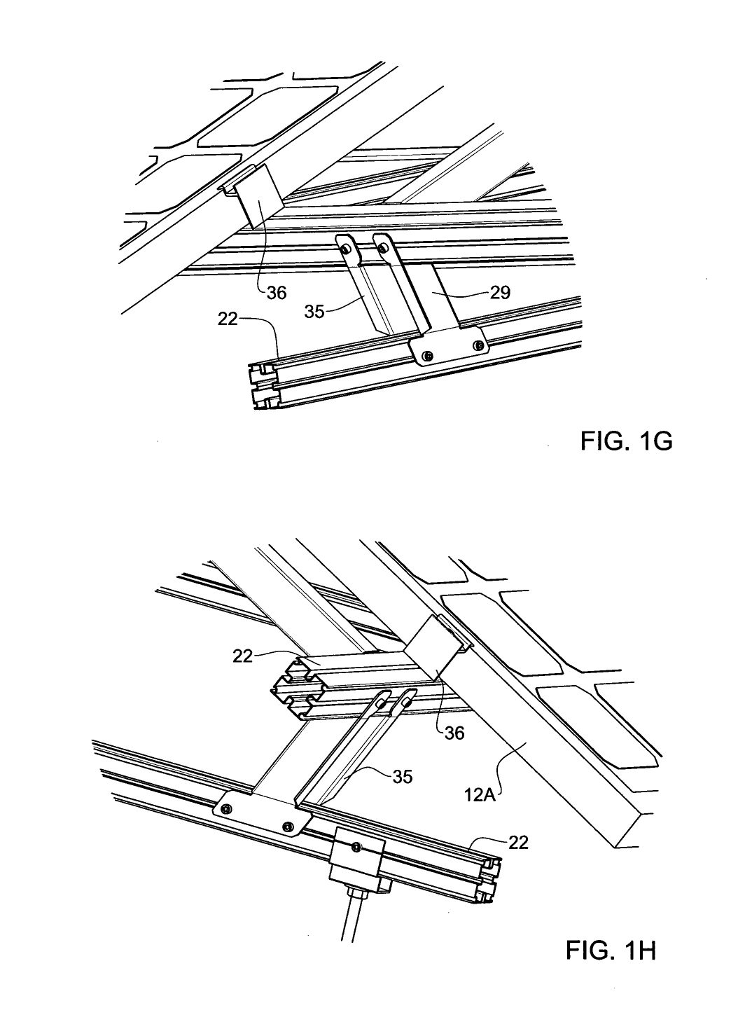

FIGS. 1A to 1D illustrate a solar collector construction generally designated 10, comprising a plurality of solar panels 12A, 12B, 12C mounted on a rigid support construction generally designated 20 for supporting the solar panels at an inclined position, optimally facing the sun.

The support construction is assembled of a plurality of construction beams 22 assembled so as to give rise to the desired support construction. The construction beams 22 are coupled to one another by a plurality of coupling brackets of various types, (e.g. L-shaped brackets 26, inclined-mounting brackets 28, and I-shaped brackets (not illustrated in FIGS. 1A through 1D) and further there are provided a plurality of support brackets 32 for supporting the construction beams over a surface bearing the construction system 10, as will be discussed hereinafter in further detail.

It is also noted that as the construction beams 22 are at times of considerable length, it may be required to coextensively couple such construction beams to one another in a rigid manner. This is facilitated by an insert coupling beam (referred to hereinafter in further detail with reference to other figures).

Further noted in FIGS. 1A to 1D, the solar panels 12A to 12C are secured to the respective bearing construction beams by a plurality of fasteners 36 configured for clamping respective edges of the solar panels to the support beams 22, as will become apparent hereinafter.

In FIG. 1E there is illustrated a solar panel array comprising three solar panels 12A, 12B and 12C wherein the support construction 20 is mounted on a corrugated roof 38 and wherein the construction system is mounted and fixed to the roof by a plurality of I-shaped brackets 35 (coupling construction beams to other elongate construction elements 40) and a plurality of support brackets 46 for supporting the construction over the corrugated roof 38.

FIG. 1F is directed to a system of the concerned disclosure wherein the support construction is placed on a ground surface and is supported to a plurality of heavy concrete slabs 39 by U-like support brackets 41 which are screw coupled into the slabs 29 for height adjustment.

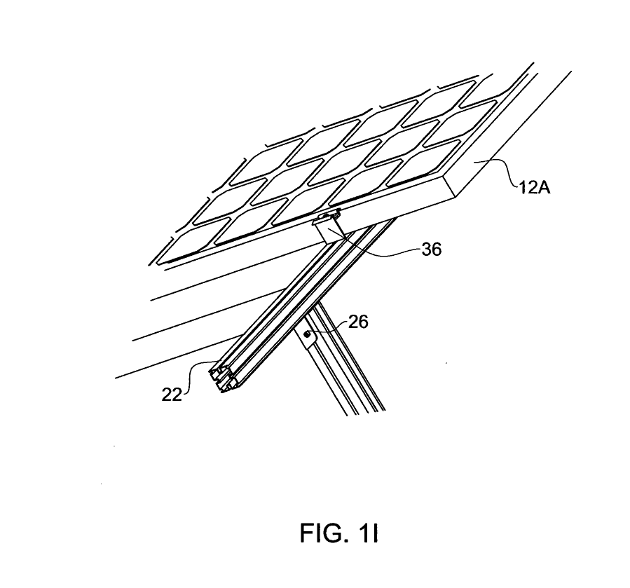

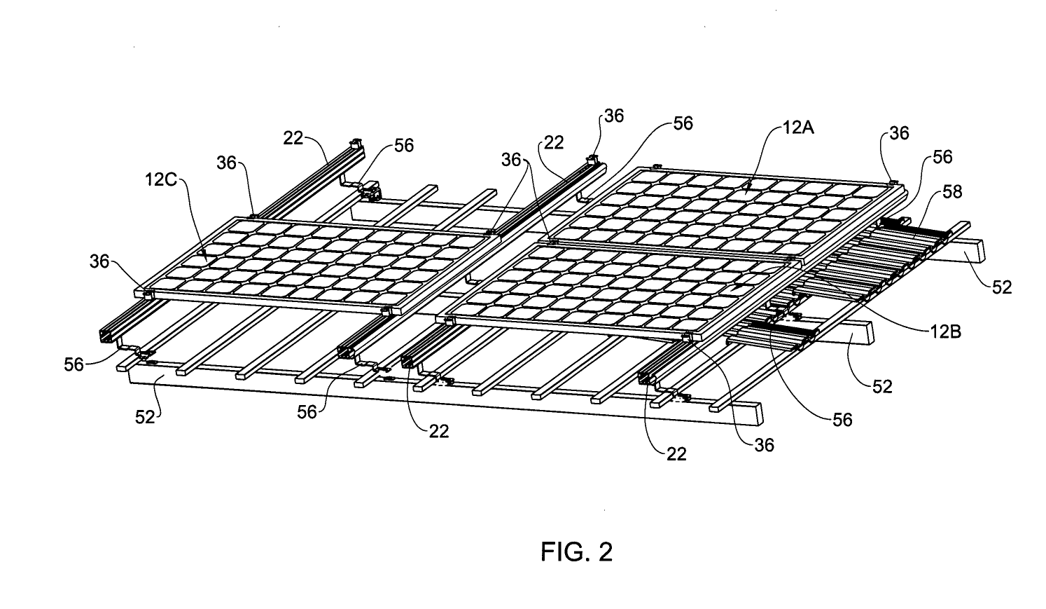

Turning now to FIG. 2 there is a solar collecting of the type disclosed hereinbefore, wherein solar panels 12A, 12B and 12C are mounted on elongate construction beams 22 and secured thereto by a plurality of fasteners 36 as will be discussed hereinafter. The elongate construction beams 22 are in turn secured to roofing elements 52 by a plurality of brackets 56 configured for extending through the roof tiles 58, in a manner which substantially does not interfere with the tiling system, i.e. does not cause a problem as far as water penetration therethrough.

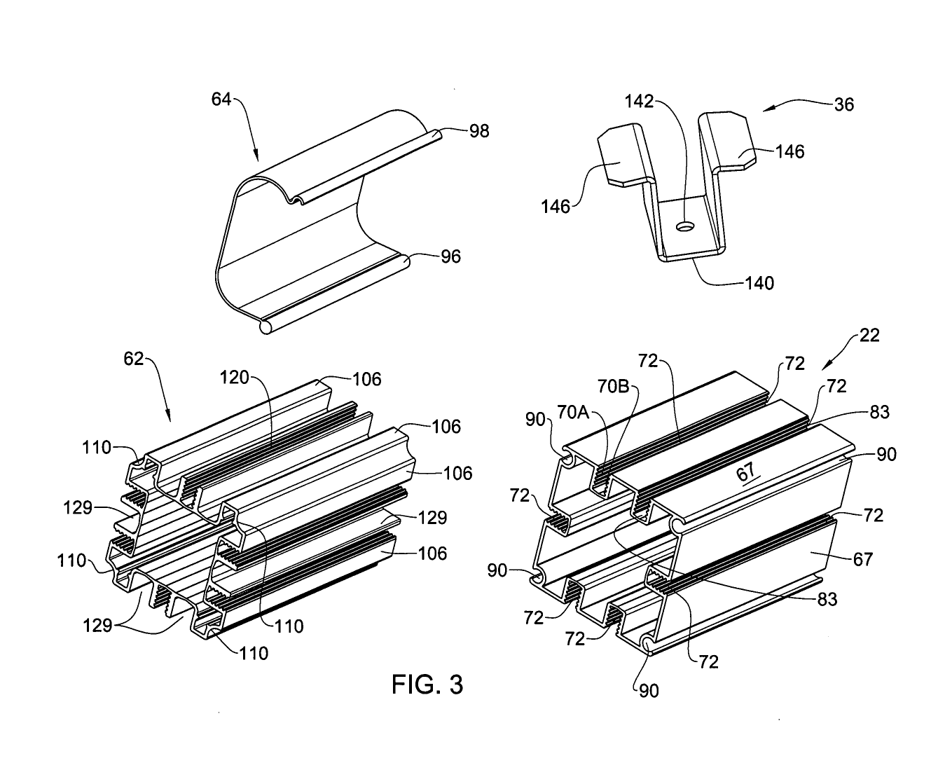

FIG. 3 illustrates several components useful in a construction system of the aforementioned disclosure, comprising a construction beam 22, an insert coupling beam 62, a raceway concealing cover 64 and a panel fastener 36.

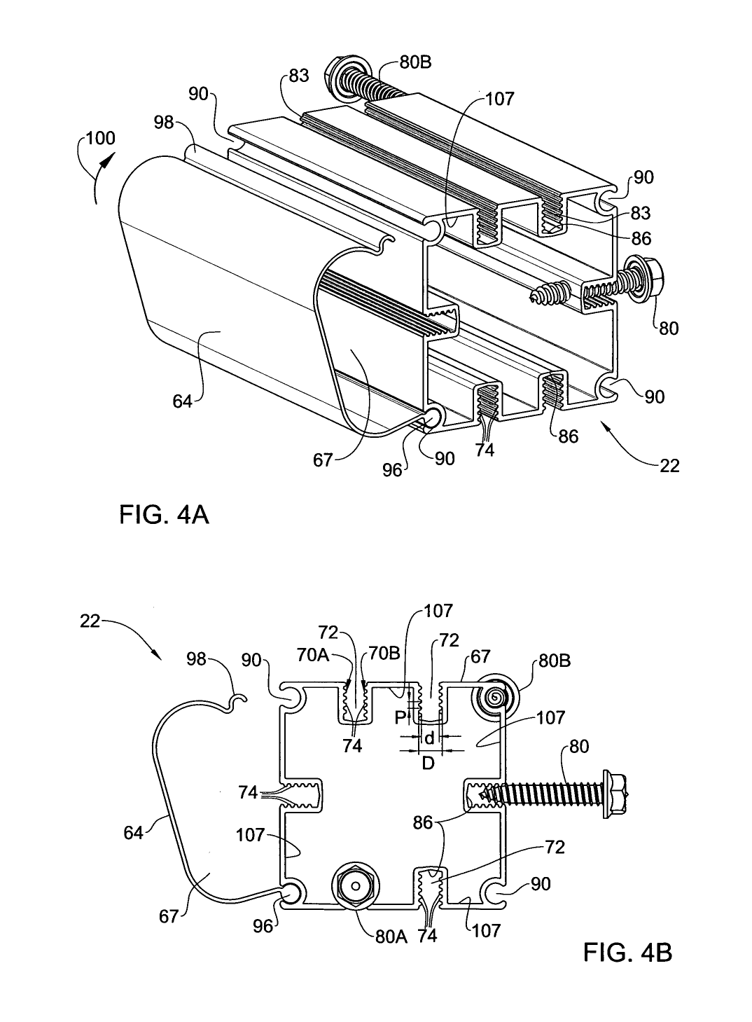

Referring first to the construction beam 22 it is configured as an elongate extruded profile made for example of aluminum or other suitable material and comprises a plurality of longitudinal grooves 72 parallel to a longitudinal axis of the beam 22 wherein the top and bottom faces of the profile comprise each two such grooves and the right and left faces comprise each only one such groove. As best seen in FIG. 4B, each of the longitudinal grooves 72 is configured with a pair of facing side walls 70A and 70B defining a height H of the groove (clearly seen in FIG. 4B), and which are fitted with a plurality of spaced apart longitudinal ribs 74 projecting therefrom, which together mimic a portion of nominal threaded bore of major diameter D (i.e., the distance in a direction perpendicular to the axial direction of the groove 72 between bases 74A of opposite ribs, i.e., the distance between the facing walls 70A, 70B), minor diameter d (i.e., the distance in a direction perpendicular to the axial direction of the groove 72 between crests 74B of opposite ribs), and pitch P (i.e., the distance between crests of adjacent ribs; it will be appreciated that the same features regarding the features of the ribs 74 apply to all examples described herein, mutatis mutandis). A base wall 86 spans between the facing walls 70A, 70B. The facing walls 70A, 70B and base wall 86 together impart a U-shaped form to the groove 72.

The thread mimicking portion defined by the grooves 72 will facilitate screw coupling a bolt 80 of corresponding nominal diameter. It is however appreciated that such a screw 80 may either be screwed into the threaded cavity of groove 72 or it may be slidingly introduced through one of the open edges 83 of the groove 72. It is appreciated that the longitudinal ribs 74 of facing side walls are not equi-leveled, i.e. the ribs on one face are staggered versus those of the facing side wall.

As mentioned, the ribs 74 together mimic a portion of a nominal threaded bore of major diameter D, minor diameter d, and pitch P. As such, a screw or bolt having a thread which would mate with a threaded bore characterized by the characteristics D, d, and P of the ribs 74 would be screwably received by the groove 72. The groove may be designed such that the major diameter D and height H thereof are related to another according to the following:

H/D≦1.8

In addition, the construction beam 22 is designed and constructed such that the groove 72 and constituent parts thereof maintain a screw therein so that an axial force F necessary to remove it from the groove, when the screw fully penetrates (i.e., it will be appreciated there herein the specification and claims, the term “fully penetrates” when used in the context of a screw indicates that the screw is threaded within the penetrated element such that only the largest diameter of the threaded portion of the screw is within the element) the base wall 86, is given by:

F<2.02×TYS×D

wherein F is the axial force in newtons necessary to remove a screw from the groove 72, TYS is the tensile yield strength in N/mm² of the material of the construction beam 22, and D is the major diameter of the groove in millimeters. The design force may be realized, e.g., by providing the base wall 86 of the groove 72 in such a way so as to require a greater axial force to remove a screw therefrom, etc.

It is further noticed that the base wall 86 may taper slightly, such that the apex thereof constitutes a weakened portion to facilitate easy penetration of a screw therethrough.

It is further noticed that the dimension D of grooves 72 is such that it facilitates forced screwing of a screw 80A, having substantially similar diameter as screw 80 where the screw effectively machines a threading through the longitudinal ribs 74.

Further noticed, at each respective corner of the construction beam 22 there is formed a longitudinal recess 90 having a substantially circular cross-section and facilitated for sliding or alternatively, snap-engagement of a raceway concealing cover 64 formed with a respective cylindrical edge 96 and a semi-circular edge 98, the former constituting a pivot axis for snap engagement of the concealing cover 64 into its locked position by pivotal displacement in direction of arrow 100 (FIGS. 4A and 4B) into snap engagement with the upper recess 90 of the construction beam 22. It is apparent from the drawings that the diameter of the ribs 90 is such as to be capable of receiving a screw 80B (FIG. 4B) which screw is of substantially similar nominal diameter as screw 80, and which during screw fastening into a recess 90 will machine a corresponding threading therethrough. Once mounted on the construction beam 22 a raceway 66 is established through which wires, cables and the like may be passed.

It is appreciated that the number of longitudinal grooves configured on the construction beam 22 may differ as required. In addition, the grooves may be of different size and orientation (for example, the side walls of a groove may be inclined with respect to side walls of the construction beam).

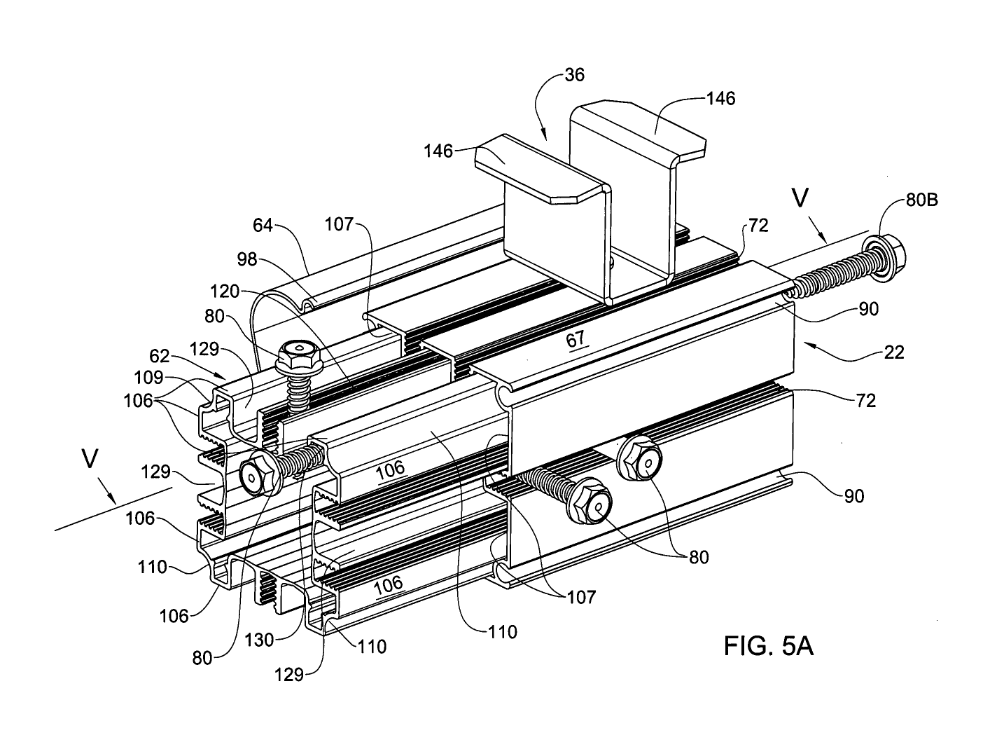

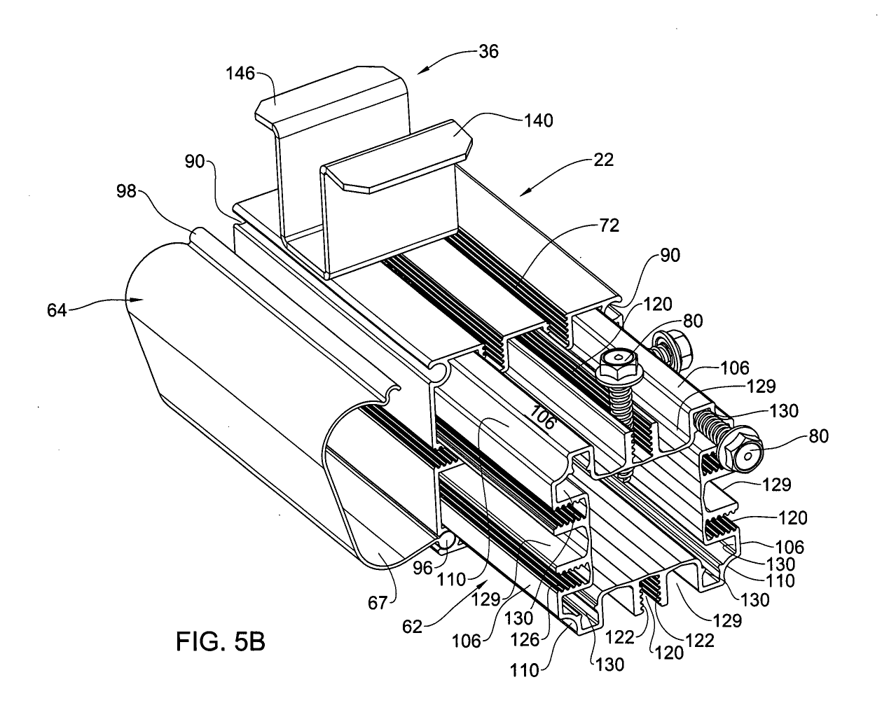

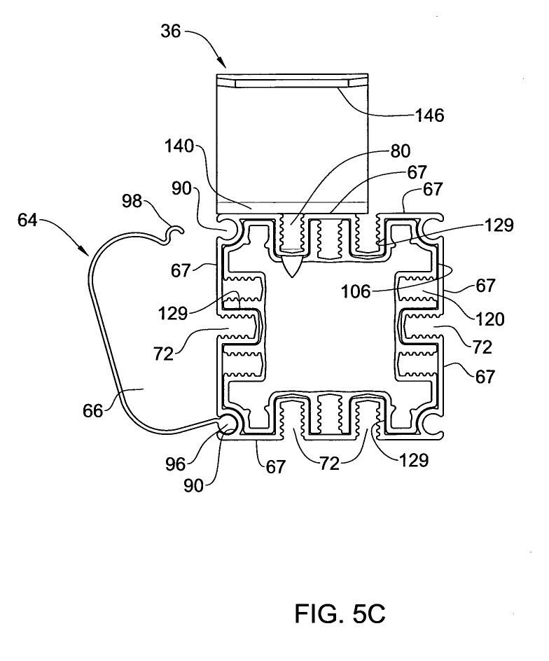

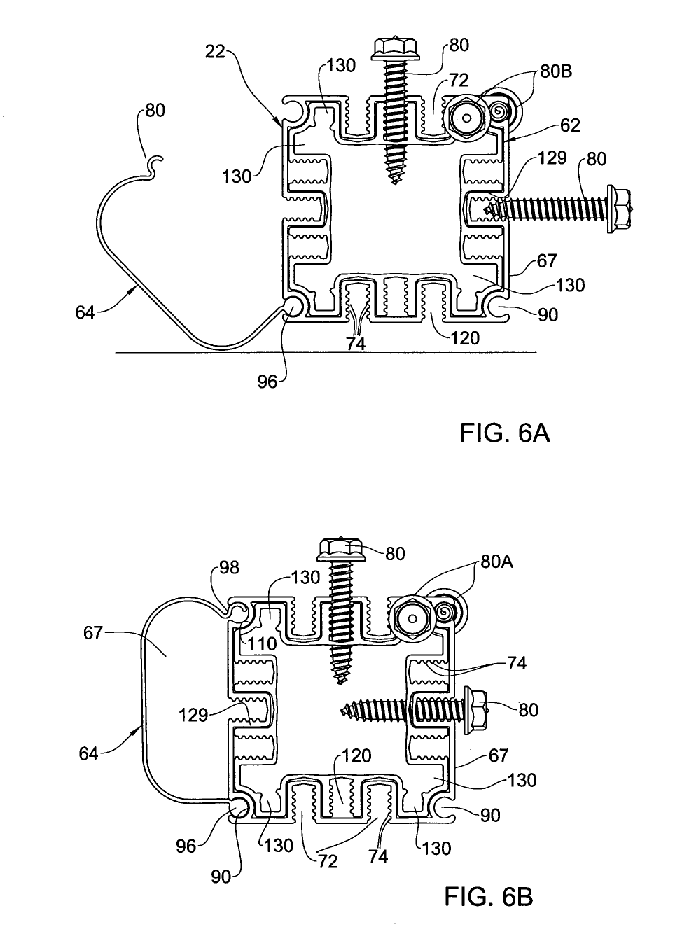

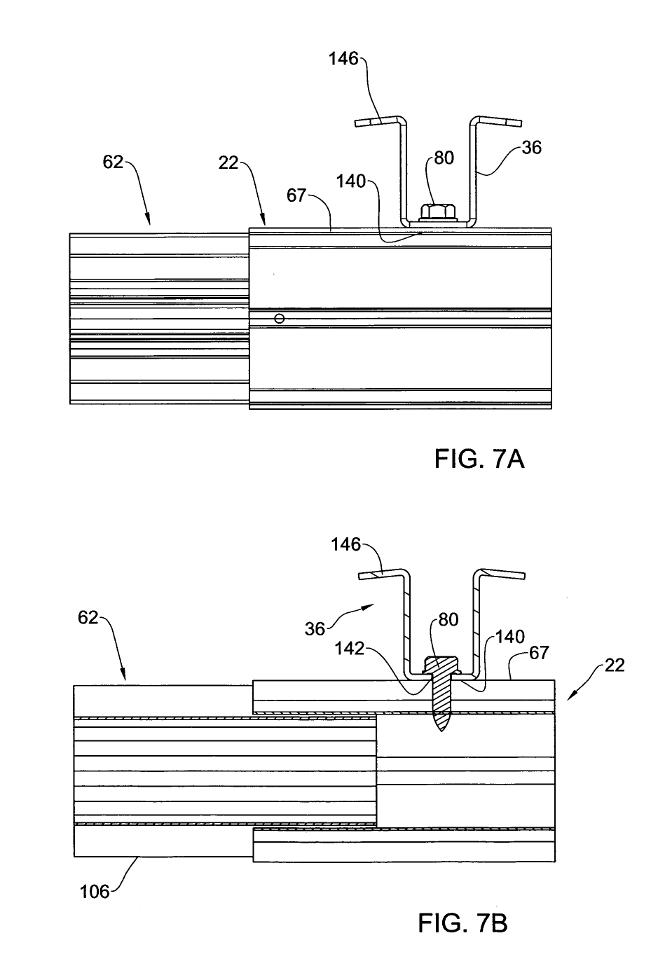

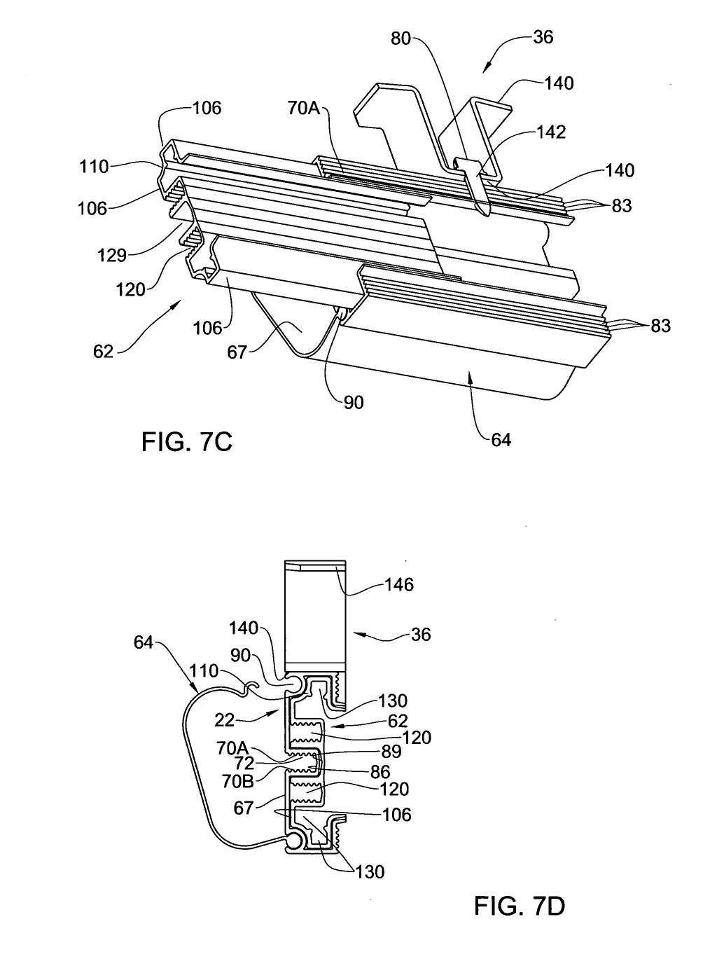

Turning now to the insert coupling beam 62, it is shaped and configured with external dimensions for snuggly sliding within the construction beam 22, as clearly illustrated in FIGS. 5 and 6. The insert coupling beam 62 is also typically made in an extrusion process and is configured with substantially flat, smooth surfaces 106 which at the assembled position is slidingly accommodated and in contact with respective inner surfaces 107 of the construction beam 22. Likewise, the insert coupling beam 62 is configured at its four corners with an arced recess 110 conforming with the inner shape of the longitudinal recess 90 formed in the, with the overall section of the insert coupling beam 62 corresponding with that of the construction beam 22, fitted for sliding though snugly receiving therein.

It is further appreciated that the insert coupling beam 32 is configured with a plurality of longitudinal grooves 120, each formed with a pair of facing side walls 122, each side wall formed with a plurality of parallely extending, spaced apart longitudinal ribs 126 which together give rise to creating a portion of nominal threaded bore, namely a threaded groove similar to the disclosure in connection with the construction beams 22. In the particular example, the mimicking threaded portion of grooves 120 mimics a threading of diameter D, similar to that of the grooves 72 of the construction beam 22, wherein the same screw 80 may be used for either screw coupling, substantially vertically into the threaded groove 120 or parallel to the longitudinal axis of the groove. In the present example the insert coupling beam 32 is formed with a plurality of grooves 129 at the assembled position snugly receive the opposite extensions of grooves 72 formed in the construction beam 22. It will be appreciated that the grooves 120 of the insert coupling beam 32 may be designed according to the same criteria regarding the height/diameter ration and axial force required for removal of a screw may be the same as described above with reference to the grooves 72 of the construction beam 22.

Also noticed, the insert coupling beam 62 is formed at its respective corners with inward facing longitudinal grooves 130 into which the same nominal sized screw 80 may be screwed (however resulting in machining a thread in order to retain the screw at a tight screw coupling engagement).

As for the coupler 36, it is noticed to have an inverted Ω—like shape with a substantially flat bottom surface 140 formed with a throughgoing aperture 142 and two lateral panel retention flaps 146.

The arrangement is such that by utilizing a screw 80, the coupler 36 is secured to either the construction beam 22 or the insert coupling beam 62, with its bottom surface 140 bearing on the respective outer smooth surfaces (67 of the construction beam 22 or 106 of the insert coupling beam 62).

With further reference to FIGS. 5A though 7D, coupling a pair of construction beams 22 in a coextensive manner is obtained by introducing an insert coupling beam 62 into two respective adjoining end portions of construction beams 22 and securing of the insert coupling beam to the respective construction beams by appropriate screws 80, once the respective foreheads (end edges) of the construction beams are in compact or close proximity to one another. It is appreciated that the screws 80 are easily screwed into the threaded portion of the grooves 72 of the construction beams 22 whilst penetration through the base walls 86 and 89 respectively of the grooves of the construction beam and the insert coupling beam requires applying of torque.

The screws used for securing and positioning of the insert coupling beam within the construction beam may be the same screws used for fixation of the couplers 36 to the construction beam 22 (as illustrated in FIGS. 5A though 7D).

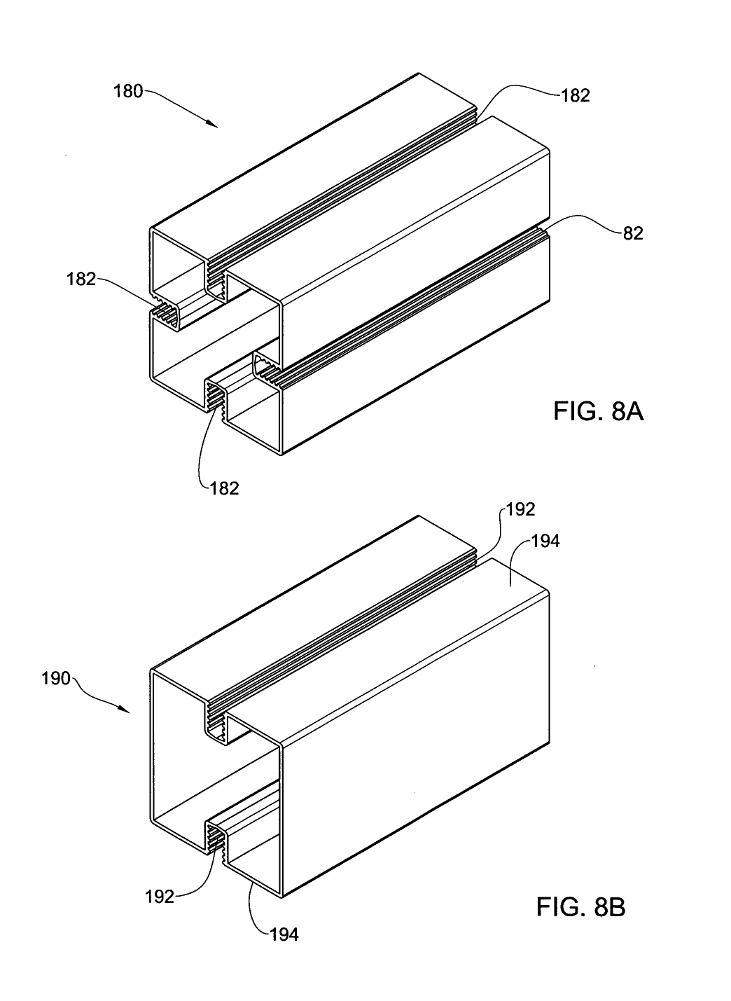

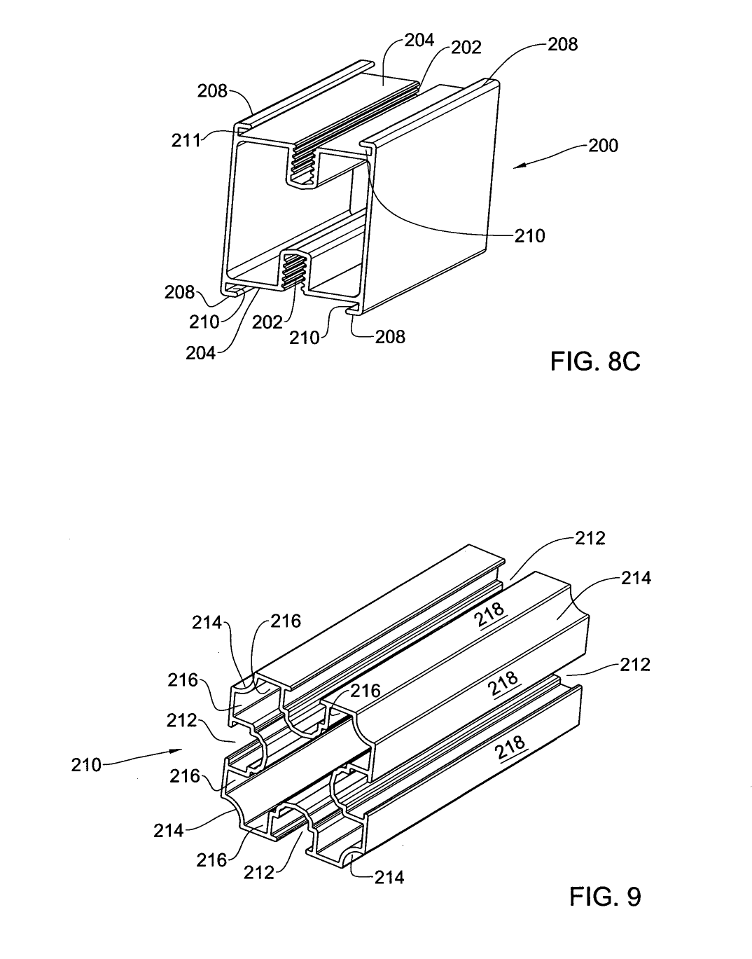

Turning now to FIGS. 8A to 8C there are illustrated three different examples of construction beams, wherein in FIG. 8A the construction beam 180 has a rectangle cross section with four longitudinal ribbed grooves 182, symmetrically disposed about the perimeter of the construction beam. The construction beam 190 of FIG. 8B has a rectangle cross section with only two longitudinal ribbed grooves 192, disposed about opposite faces 194 of the construction beam. The construction beam 200 of FIG. 8C is similar to that disclosed in connection with FIG. 8B and comprises two longitudinal ribbed grooves 202, disposed about opposite faces 204 of the construction beam, however with integral flanged portions 208 constituting a longitudinal grove 211.

FIG. 9 illustrates an insert coupling beam 210 having a substantially symmetric cross section and formed with four longitudinal grooves 212, each disposed on a respective face thereof, however wherein said groves are plain grooves, i.e. devoid of the thread-forming ribs disclosed in connection with the previously disclosed insert coupling beam. Nonetheless, insert coupling beam 210 is configured for cooperation and coupling engagement with construction beams as discussed in hereinabove. For that purpose it is shaped and sized accordingly wherein the grooves 212 will accommodate the respective grooved portions of a respective construction beam and is formed with corner arced recesses 214, longitudinal grooves 216 for screw engagement, flat and smooth external surfaces 218, etc.

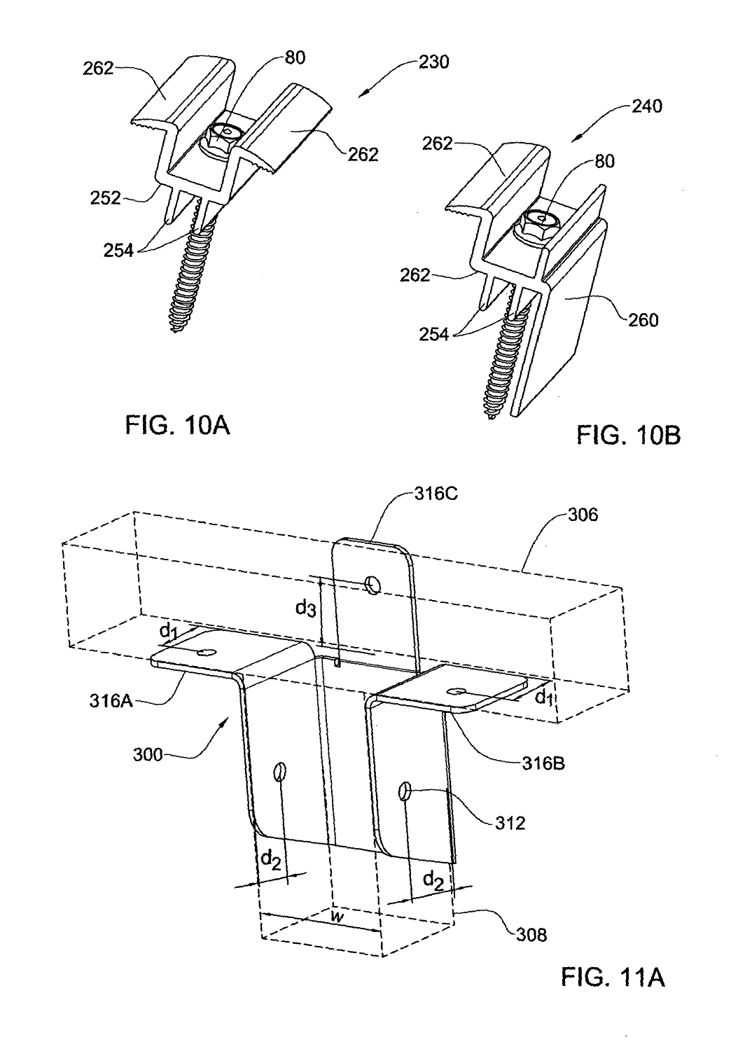

FIGS. 10A and 10B illustrate fasteners/couplers of the type used for example to secure solar panels to the support construction, as already discussed in connection with fastener 36 (FIGS. 5A through 5C). The fasteners 230 and 240 of FIGS. 10A and 10B respectively, are each formed with a base surface 252 for bearing against the external surface 67 of a construction beam, with a pair of downwards facing ribs sized for snugly fitting into a longitudinal groove 72 of a construction beam. An aperture is formed at the base of the coupler, through which a fastening screw 80 extends, which screw serves both for setting and tightening the fastener to the construction beam and for clamping a solar panel or the like (FIGS. 1 and 2). Fastener 240 of FIG. 10B differs from Fastener 230 of FIG. 10A in the existence of a downwardly extending flanged portion 260 and the provision of only one clamping/retention flap 262. Such a fastener is suitable for use as an end fastener (clamping only one solar panel) whilst fastener 230 is configured for simultaneous clamping two adjacent panels.

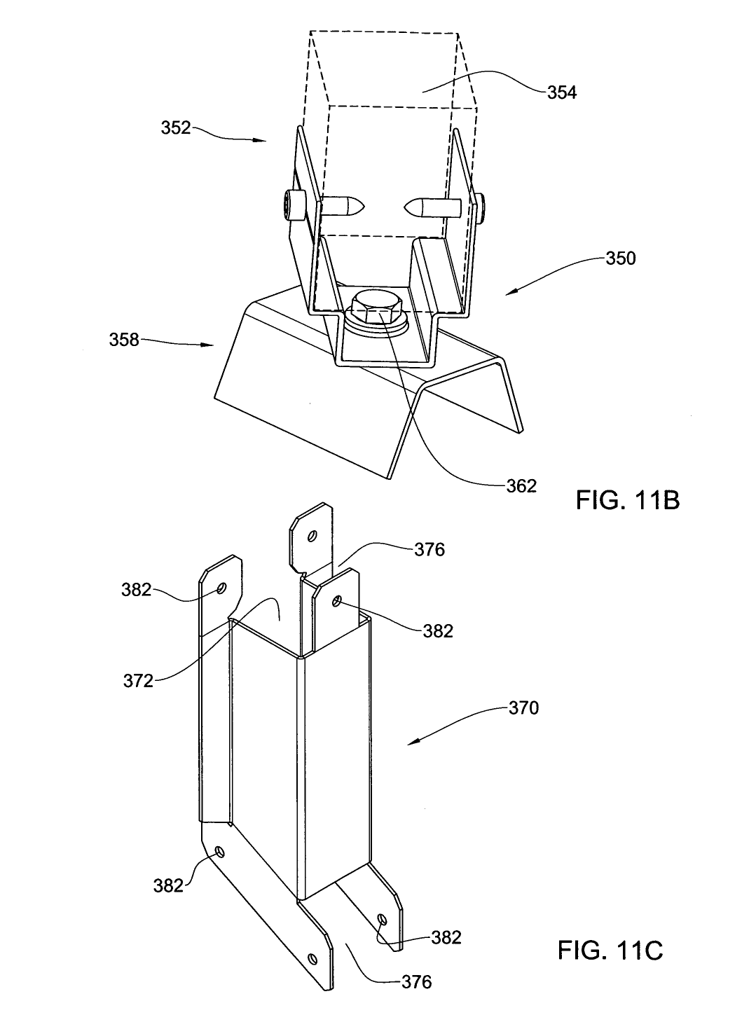

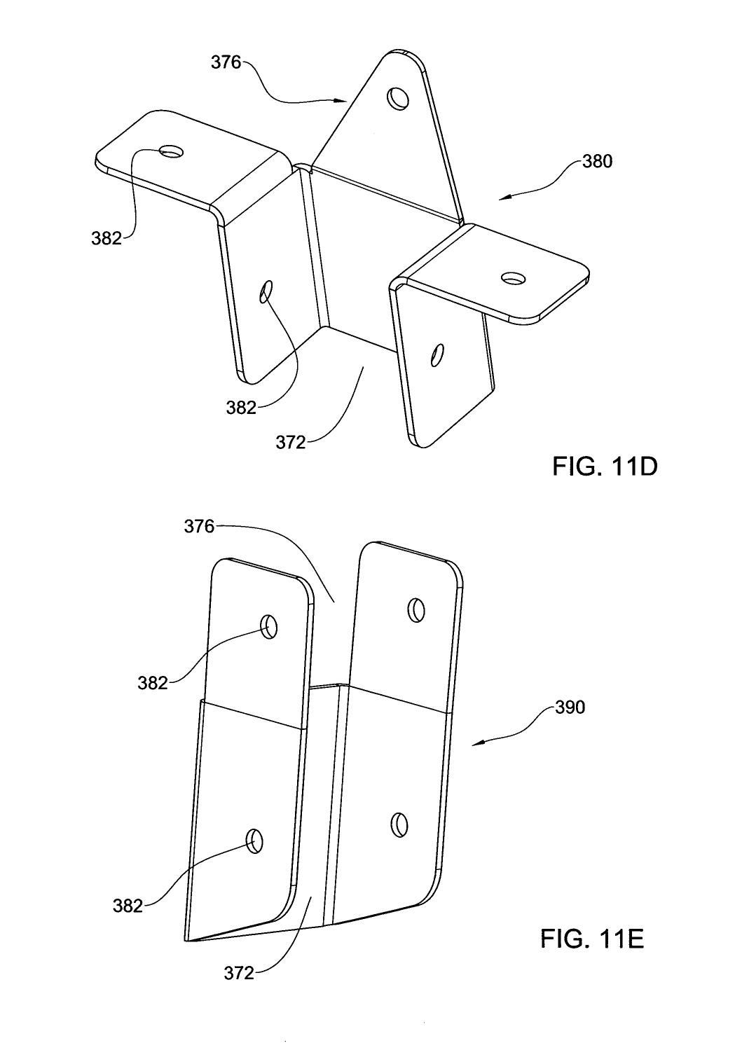

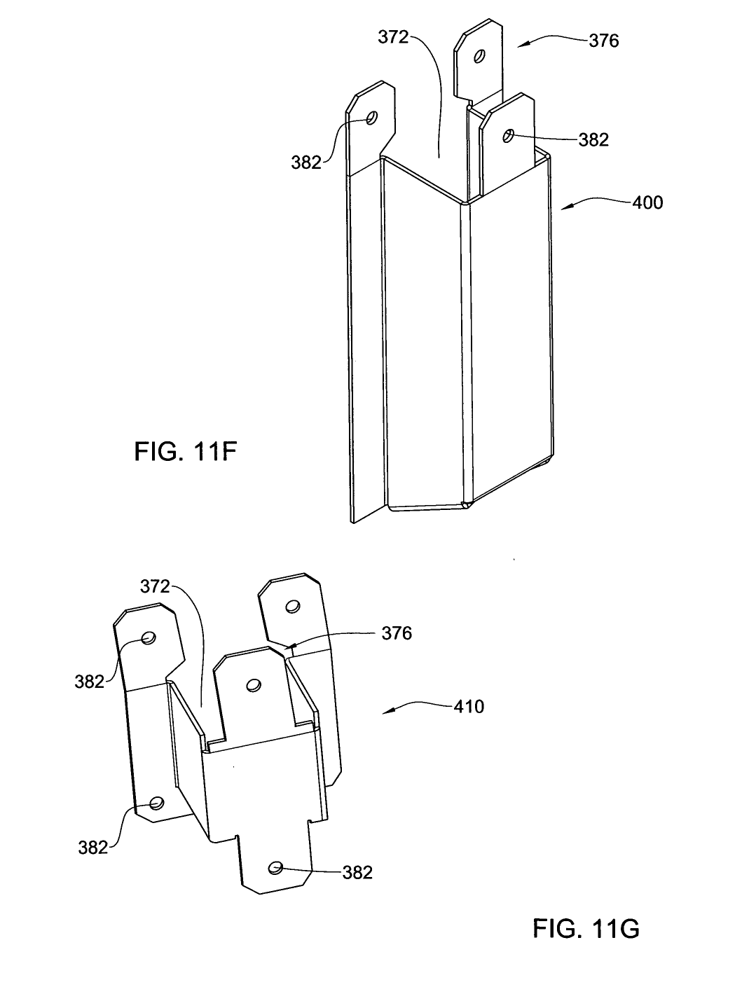

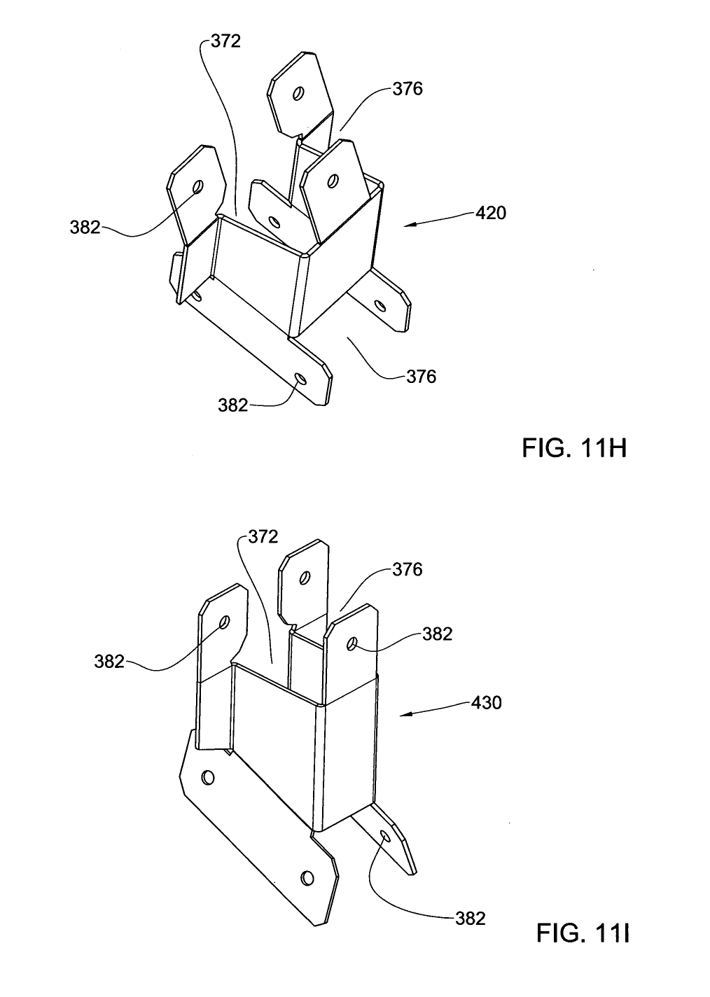

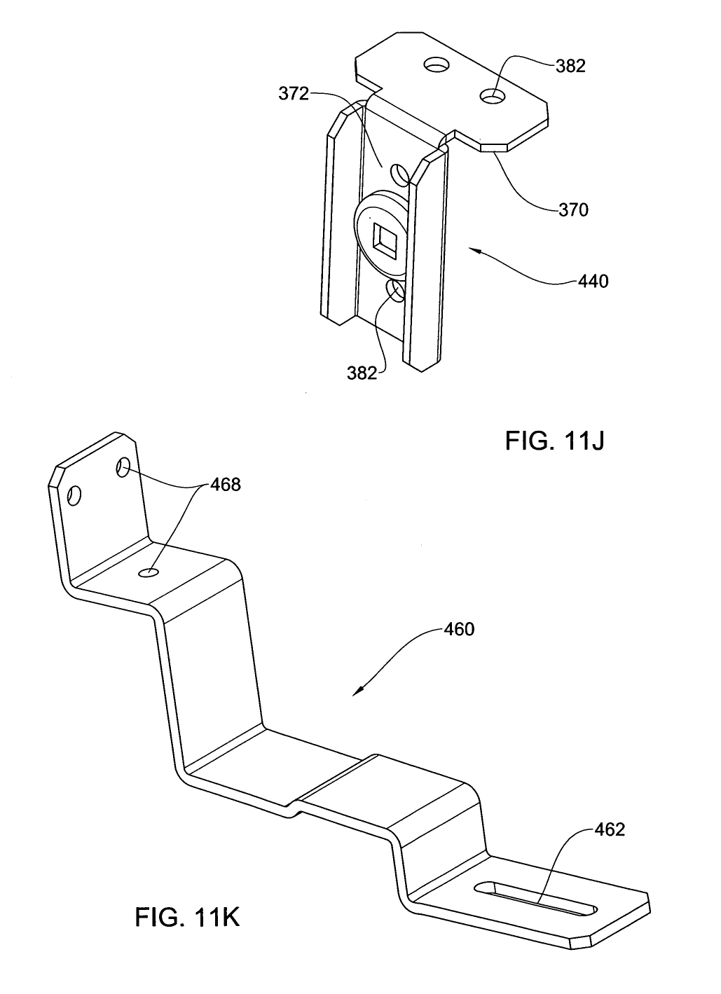

Noting modularity of the system, the construction beams may be coextensively elongated by the provision of insert coupling beams as discussed hereinabove and wherein a construction may be erected by securing construction beams to one another or to support fixtures, by the provision of suitable support brackets that will be discussed hereinafter in connection with FIGS. 11A to 11K.

The coupling bracket 300 of FIG. 11A for coupling at least one second construction beam 306 (schematically represented by dashed lines) to a first construction beam 308 (schematically represented by dashed lines) at an intersecting angle (right angle at the present example), said coupling bracket 300 comprising a first, U-like shaped flanged portion 312, for articulation to the first construction beam 308, and a second flanged portion in the form of flaps 316A, 316B and 316C extending at right angles. The first U-like shaped flanged portion 312 is shaped and sized for accommodating construction beam 308, whilst the second construction beam 306 bears over the flaps 316A and 316B and supported by flap 316C. The arrangement being such that apertures are formed in each of the flanges, said apertures positioned such that at the assembled position they extend opposite a respective ribbed grove (e.g. 72 of construction beam 22) for readily screw coupling and fastening thereto. Accordingly, the position of the apertures at respective distances d₁, d₂ and d₃ correspond with the location of the groves over the construction beam. Likewise, the width W of the first flanged portion corresponds with the width of a construction beam.

FIG. 11B discloses a support bracket 350 intended for supporting an end of a construction beam of a support system of the present invention over a corrugated roof. The support bracket 350 comprises a flanged portion 352 for fixedly receiving a lower end of a construction beam 354 (schematically represented by dashed lines). Further, support bracket 350 comprises a bearing portion 358 for placing the support bracket over a corrugated surface (not shown), wherein said flanged portion 352 is pivotally secured to the bearing portion 358 by a screw 362, serving also for securing the support bracket 350 to the roof According to the particular example, the flanged portion 352 and the bearing portion 358 are pivotally in a liquid tight manner, to prevent water leaking through the screw receiving aperture. Such liquid tight arrangement is obtained by providing a water-tight gasket.

The example illustrated in FIGS. 11C to 11K are directed to support brackets 370 through 440, all sharing the common features of comprising at least a first support beam receiving portion (i.e. at least partially embracing a construction beam), collectively designated 372, and at least one other coupling portion collectively designated 376, for engagement with an elongate construction element, and wherein both said beam receiving portions 372 and coupling portions 376 are configured (shaped and sized) for receiving a respective end or intermediate portion of a support beam, or elongate beam according to the disclosed subject matter, and wherein each of the receiving portions 372 and coupling portions is formed with one or more apertures 382 conforming with the location of the ribbed grooves formed on said beams and elongate members, for secure fastening and fixture thereto.

FIG. 11K illustrates a fastener bracket 460 configured for supporting a construction beam in accordance with the disclosed subject matter, said bracket configured for extending through roof tiles (seen for example in FIG. 2), in a manner which substantially does not interfere with the tiling system, i.e. does not cause a problem as far as water penetration therethrough. For that purpose the fastener bracket 460 is a substantially flat element with an irregular shape conforming with the gutter gap extending between adjacent tiles. Aperture 462 serves for fixing the bracket to the roof construction beams, and apertures 468 serve for securing to the construction.

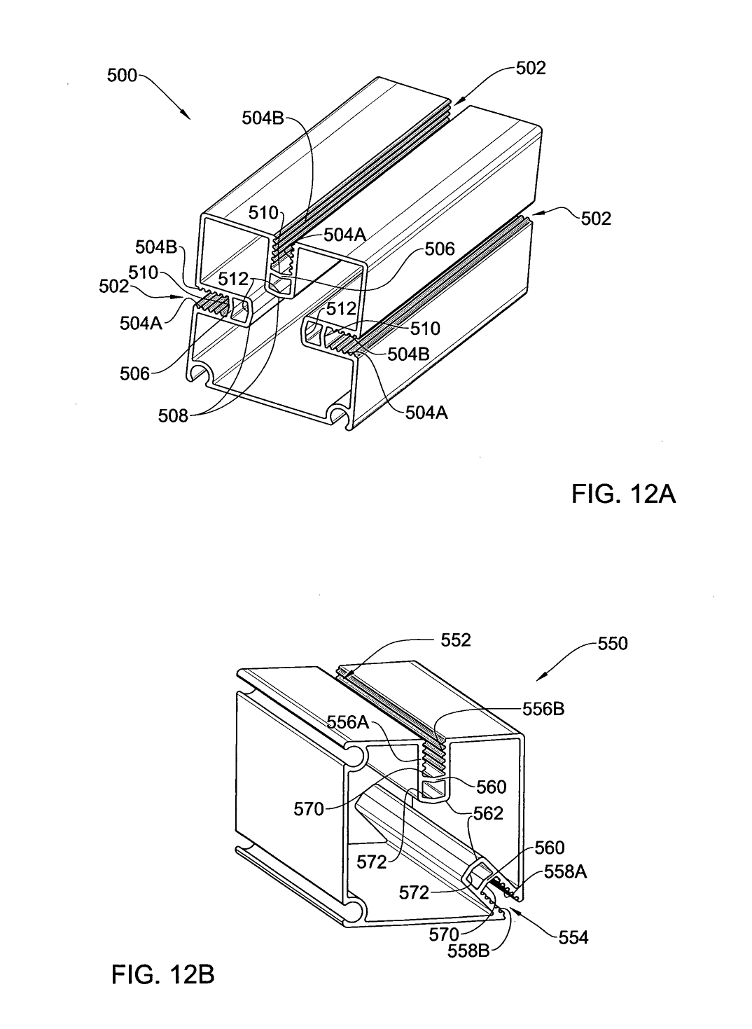

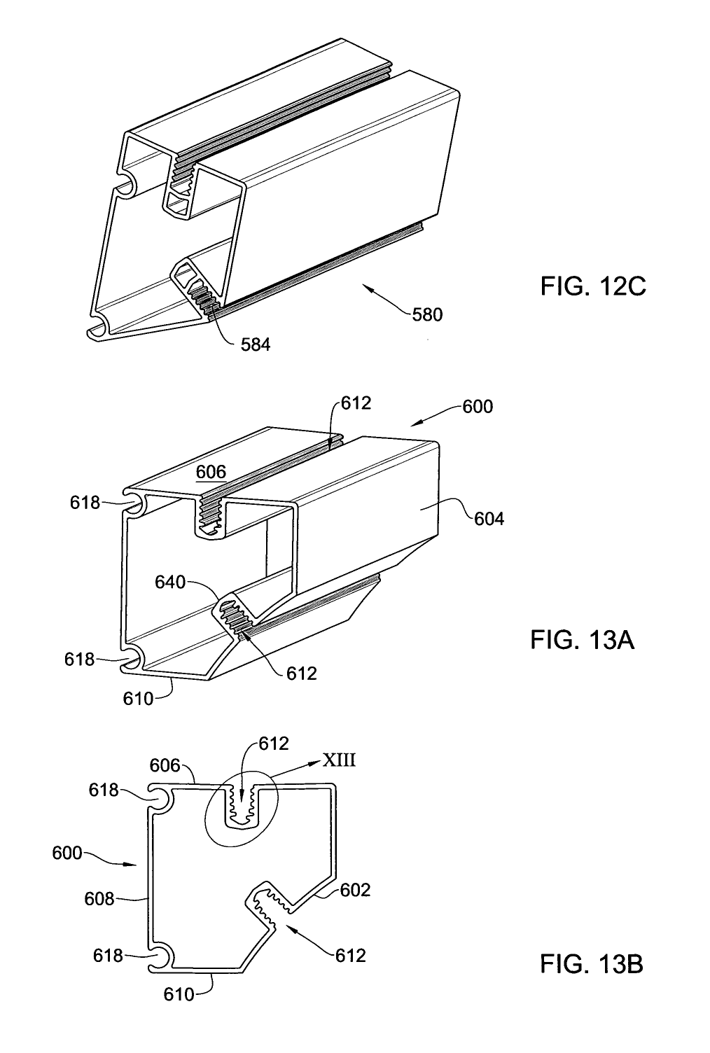

FIGS. 12A, 12B and 12C illustrate three different examples of construction beams, wherein in FIG. 12A the construction beam generally designated 500 has a rectangle cross section with three longitudinal ribbed grooves 502, wherein each of the longitudinal grooves has a substantially U-like shaped cross-section composed of two facing ribbed side walls 504A and 504B, and a double walled base wall extending between two ribbed side walls, the two base walls 506 and 508 being spaced apart and parallel to one another, Furthered noted, the base walls 506 and 508 of the longitudinal grooves each have a tapering cross section with an apex 510 and 512 respectively, extending parallel and at a midsection of the respective groove. Similar to previous examples, the construction beam 500 is configured with a pair of longitudinal recess 522 having a substantially circular cross-section, and facilitated for sliding or alternatively, snap-engagement of a raceway concealing cover.

FIG. 12B is directed to a construction beam generally designated 550 having a rectangle cross section with two longitudinal ribbed grooves of which a first groove 552 extends on a face of the construction beam with its ribbed side walls 556A and 556B extending substantially parallel to side faces of the construction beam, and a second groove 554 extending along an edge of the rectangle construction beam, with its side walls 558A and 558B intersecting the faces of the construction beam (in fact, in the example illustrated the side walls 558A and 558B are parallel to a diagonal of the rectangle). Similar to the previous example, both the longitudinal grooves 552 and 554 have a substantially U-like shaped cross-section composed of two facing ribbed side walls 556A and 556B, and 558A and 558B, respectively, with a double walled base wall extending between two ribbed side walls, the two base walls 560 and 562 being spaced apart and parallel to one another. The base walls 560 and 562 each have a tapering cross section with an apex 570 and 572 respectively, extending parallel and at a midsection of the respective groove. This construction beam too is configured with a pair of longitudinal recess 522 having a substantially circular cross-section, and facilitated for sliding or alternatively, snap-engagement of a raceway concealing cover.

The construction beam 580 of FIG. 12C is similar to that disclosed in connection with FIG. 12B though it has a trapezoidal cross-section and comprises two longitudinal ribbed grooves 582 and 584, which are configured in a similar fashion as discussed in connection with the examples of FIGS. 12A and 12B.

It is noted that the double walled base as disclosed in connection with the examples of FIGS. 12A, 12B and 12C is intended for both rigidifying the cross section of the beam and, in particular, to provide a larger engaging section area for a bolt to penetrate through and engage therewith, so as to impart it a more rigid/strong screw-coupling.

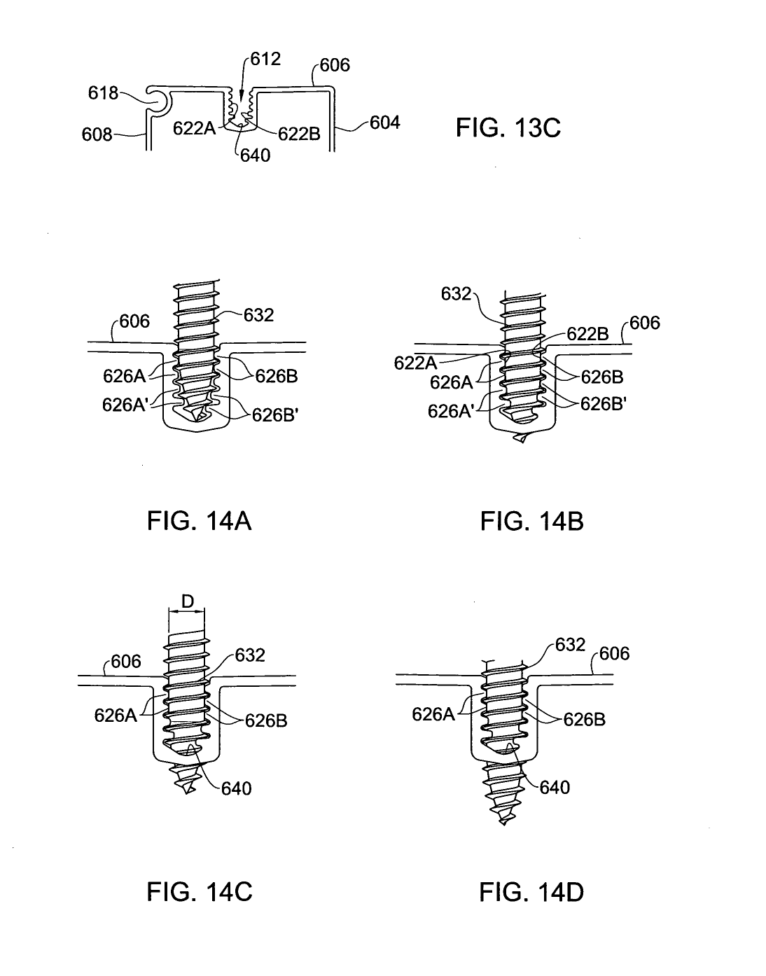

Turning now to FIGS. 13A and 13B, there is illustrated a beam generally designated 600 having a generally rectangle cross-section, however with one chamfered face 606, i.e. extending at an angle with respect to right angled faces 604, 606, 608 and 610. Faces 602 and 610 are each configured with a ribbed groove 612 as will be discussed hereinafter in further detail. Respective corners of the face 608 construction are each formed with a longitudinal recess 618, having a substantially circular cross-section and facilitated for sliding or alternatively, snap-engagement of a raceway concealing cover (e.g. 64 in FIG. 3).

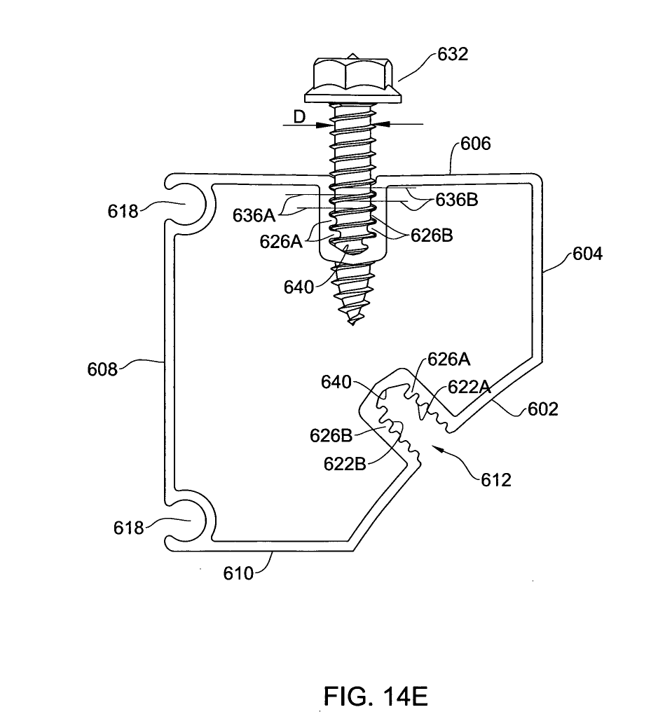

As can be seen best in the enlargements of FIGS. 13C, and 14A to 14E, the longitudinal groove 612 is configured with a pair of facing side walls 622A and 622B (clearly seen in FIGS. 13C and 14E), each side wall is formed with a plurality of parallely extending spaced apart longitudinal ribs 626A, 626A′, 626B, and 626B′, respectively which together mimic a portion of nominal threaded bore of diameter D. According to the example illustrated in FIGS. 13C through 14E, lowermost (i.e., closest to the interior of the beam; innermost) ribs 626A′, 626B′ project inwardly more that do uppermost ribs. The uppermost (i.e., farthest from the interior of the beam; outermost) ribs 626A, 626B on each side of the groove extend the same amount, i.e., their crests are parallel to each other and to the side walls. The crests of all of the ribs 626A, 626A′, 626B, and 626B′ together form the outline of a self-tapping (forming screw).

For a groove 612 thus designed and constructed, constituent parts thereof maintain a screw therein so that an axial force F necessary to remove it from the groove, when the screw fully penetrates the base wall 86, is given by:

F<3.7×TYS×D

wherein F is the axial force in newtons necessary to remove a screw from the groove 72, TYS is the tensile yield strength in N/mm² of the material of the construction beam 22, and D is the major diameter of the groove in millimeters. The design force may be realized, e.g., by providing the base wall 86 of the groove 72 in such a way so as to require a greater axial force to remove a screw therefrom, etc.

The thread mimicking portion defined by the grooves will facilitate screw coupling a bolt 632 of corresponding nominal diameter D. It is however appreciated that such a screw 80 may either be screwed into the threaded cavity of groove or it may be slidingly introduced through one of the open edges of the grooves. It is further appreciated that the longitudinal ribs 626A and 626B of facing side walls 622A and 622B, respectively are not equi-leveled, i.e. the ribs on one face are staggered versus those of the facing side wall. This is exemplified by parallely extending lines marked 636A and 636b, respectively, in FIG. 14E.

It is further noted that the each groove 612 has a slightly tapering base wall 640, the apex of which constituting a weakened portion to facilitate easy penetration of a screw therethrough. However, in the examples of FIGS. 13A through 14D the base wall is thickened to assume a V-like shape, thereby increasing surface area contact with a screw penetrating therethrough, i.e. improving thread gripping of the screw. This results in better shear/tear resistance.

Those skilled in the art to which this disclosed subject matter pertains will readily appreciate that numerous changes, variations, and modifications can be made without departing from the scope of the disclosed subject matter mutatis mutandis.

1. A construction system comprising:
(a) a construction beam extending along a longitudinal axis and formed with at least one longitudinal groove parallel to said longitudinal axis; and
(b) an insert coupling beam snugly slideable within the construction beam and fixedly secured by virtue of at least threaded fasteners extending through said longitudinal groove;
wherein at least one of said construction beam and said insert coupling beam is comprising at least one U-like shaped groove defined between a pair of facing side walls and a base wall spanning therebetween, said side walls being formed with a plurality of parallel, spaced apart longitudinal ribs projecting therefrom, which together mimic a portion of nominal threaded bore, and wherein the groove is formed such that:
H/D≦1.8
wherein H is the height of the groove, and D is the distance between said side walls, and wherein the axial force necessary to remove a screw threaded therein the groove and fully penetrating said base wall is given by:
F<3.7×TYS×D
wherein F is said axial force in newtons, and TYS is the tensile yield strength in N/mm² of the material of the construction beam.

2. A construction system according to claim 1, wherein innermost ribs project farther than do outermost ribs, at least some of said outmost ribs extending from each of the sidewalls extending the same amount as each other.

3. A construction system according to claim 1 wherein all ribs project substantially the same distance, said axial force being given by:
F<2.02×TYS×D.

4. A construction system according to claim 1, wherein the construction beam is fitted with at least a pair of longitudinal ribs for coupling thereto a raceway concealing cover.

5. A construction system according to claim 4, wherein the raceway concealing cover is slidingly articulated within the longitudinal ribs of the construction beam.

6. A construction system according to claim 4, wherein the raceway concealing cover is snappingly articulated within the longitudinal ribs of the construction beam.

7. A construction system according to claim 1, wherein the at least one longitudinal groove is configured for receiving a screw axially screwed into a longitudinal groove.

8. A construction system according to claim 4, wherein the longitudinal ribs are configured for receiving a screw screwed axially into the longitudinal ribs.

9. A construction system according to claim 1, further comprising a coupling bracket for coupling at least one second construction beam to a first construction beam at an intersecting angle, said coupling bracket comprising a first flanged portion for articulation to the first construction beam and at least one second flanged portion for articulation to the at least one second construction beam, wherein said flanged portions are formed with apertures conforming with the location of the at least one groove formed on each construction beam.

10. A construction system according to claim 1, further comprising a coupling bracket for coupling a second construction beam to a first construction beam at an intersecting angle, wherein said coupling bracket comprises a second construction beam receiving portion and at least one securing flap for fastening flush against said first construction beam, both said receiving portion and said at least one securing flap are fitted with apertures positioned in register with the longitudinal groove for screw coupling therewith.

11. A construction system according to claim 10, wherein the coupling bracket comprises three securing flaps of which two extend coplanar and are configured for securing to a first surface of the first construction beam, and a third securing flap for securing to a second surface of the first construction beam.

12. A construction system according to claim 1, further comprising a support bracket for supporting an end of a construction beam over a surface, said support bracket comprising a flanged portion for fixedly receiving the end of the construction beam, and a bearing portion for placing the support bracket over a surface, wherein said flanged portion is pivotally secured to the bearing portion.

13. A construction system according to claim 12, wherein the flanged portion and the bearing portion are pivotally articulated by a fastener element projecting for fixing to the surface in a liquid tight arrangement.

14. A construction system according to claim 13, wherein the trough-like shaped bearing portion of the support bracket is padded.

15. A construction system according to claim 13, wherein the bearing portion of the support bracket has a substantially trough-like shape.

16. A constructions system according to claim 1, constructed for bearing a plurality of solar panels secured thereto by a plurality of fasteners configured for screw coupling to the longitudinal grooves.

17. A constructions system according to claim 1, wherein the at least one longitudinal groove is open ended.

18. A constructions system according to claim 1, wherein the at least one longitudinal groove is U-like shaped.

19. A construction system according to claim 1, wherein one or more of the one or more longitudinal grooves comprises a double walled base wall extending between two ribbed side walls, the two base walls being spaced apart and parallel to one another.

20. A construction system according to claim 19, wherein the base wall of the longitudinal groove has a tapering cross section with an apex extending at a midsection of the respective groove.

21. A construction system according to claim 19, wherein longitudinal ribs of facing side walls are parallel to one another though not equi-leveled.

22. A construction system according to claim 19, wherein the base wall is thickened to assume a reinforced v-like shape.

23. A construction beam extending along a longitudinal axis and formed with at least one longitudinal U-like shaped groove parallel to said longitudinal axis and being defined between a pair of facing side walls and a base wall spanning therebetween, said side walls being formed with a plurality of parallel, spaced apart longitudinal ribs projecting therefrom, which together mimic a portion of nominal threaded bore, and wherein the groove is formed such that:
H/D≦1.8
wherein H is the height of the groove, and D is the distance between said side walls, and wherein the axial force necessary to remove a screw threaded therein the groove and fully penetrating said base wall is given by:
F<3.7×TYS×D
wherein F is said axial force in newtons, and TYS is the tensile yield strength in N/mm² of the material of the construction beam.

24. A construction beam according to claim 23, wherein innermost ribs project farther than do outermost ribs, at least some of said outmost ribs extending from each of the sidewalls extending the same amount as each other.

25. A construction beam according to claim 23 wherein all ribs project substantially the same distance, said axial force being given by:
F<2.02×TYS×D.

26. A construction beam according to claim 23, wherein the at least one longitudinal groove is open ended.

27. A construction beam according to claim 23, wherein the at least one longitudinal groove is U-like shaped.

28. A construction beam according to claim 23, wherein one or more of the one or more longitudinal grooves comprises a double walled base wall extending between two ribbed side walls, the two base walls being spaced apart and parallel to one another.

29. A construction beam according to claim 23, wherein the base wall of the longitudinal groove has a tapering cross section with an apex extending at a midsection of the respective groove.

30. An insert coupling beam for a construction system, said insert coupling beam configured for snugly sliding within a construction beam and for fixedly securing thereto by virtue of at least one fastener, said insert coupling beam comprising at least one longitudinal U-like shaped groove defined between a pair of facing side walls and a base wall spanning therebetween, said side walls being formed with a plurality of parallel, spaced apart longitudinal ribs projecting therefrom, which together mimic a portion of nominal threaded bore, and wherein the groove is formed such that:
H/D≦1.8
wherein H is the height of the groove, and D is the distance between said side walls, and wherein the axial force necessary to remove a screw threaded therein the groove and fully penetrating said base wall is given by:
F<3.7×TYS×D
wherein F is said axial force in newtons, and TYS is the tensile yield strength in N/mm² of the material of the insert coupling beam.

31. An insert coupling beam according to claim 30, wherein innermost ribs project farther than do outermost ribs, at least some of said outmost ribs extending from each of the sidewalls extending the same amount as each other.

32. An insert coupling beam according to claim 30, wherein all ribs project substantially the same distance, said axial force being given by:
F<2.02×TYS×D.

33. An insert coupling beam according to claim 30, wherein the at least one longitudinal groove is open ended.

34. An insert coupling beam according to claim 30, wherein the at least one longitudinal groove is U-like shaped.

35. An insert coupling beam according to claim 30, wherein one or more of the one or more longitudinal grooves comprises a double walled base wall extending between said side walls, the two base walls being spaced apart and parallel to one another.

36. An insert coupling beam according to claim 30, wherein the base wall of the longitudinal groove has a tapering cross section with an apex extending at a midsection of the respective groove.

37. An elongate construction element comprising a rigid elongate tubular body formed with at least one longitudinal U-like shaped groove being defined between a pair of facing side walls and a base wall spanning therebetween, said side walls being formed with a plurality of parallel, spaced apart longitudinal ribs projecting therefrom, which together mimic a portion of nominal threaded bore, and wherein the groove is formed such that:
H/D≦1.8
wherein H is the height of the groove, and D is the distance between said side walls, and wherein the axial force necessary to remove a screw threaded therein the groove and fully penetrating said base wall is given by:
F<3.7×TYS×D
wherein F is said axial force in newtons, and TYS is the tensile yield strength in N/mm² of the material of the construction element.

38. An elongate construction element according to claim 37, wherein innermost ribs project farther than do outermost ribs, at least some of said outmost ribs extending from each of the sidewalls extending the same amount as each other.

39. An elongate construction element according to claim 37, wherein all ribs project substantially the same distance, said axial force being given by:
F<2.02×TYS×D.

40. An elongate construction element according to claim 37, wherein the at least one longitudinal groove is open ended.

41. An elongate construction element according to claim 37, wherein the at least one longitudinal groove is U-like shaped.

42. An elongate construction element according to claim 37, wherein one or more of the one or more longitudinal grooves comprises a double walled base wall extending between said side walls, the two base walls being spaced apart and parallel to one another.

43. An elongate construction element according to claim 42, wherein the base wall of the longitudinal groove has a tapering cross section with an apex extending at a midsection of the respective groove.

44. An elongate construction element according to claim 42, wherein longitudinal ribs of facing side walls are parallel to one another though not equi-leveled.

45. An elongate construction element according to claim 42, wherein the base wall is thickened to assume a reinforced v-like shape.
